(19) United States
(12) Patent Application Publication
(10) Pub. No.: US 2005/0180683 A1
(43) Pub. Date: Aug. 18, 2005

(54) Tuneable filter arrangement

(76) Inventor: Barry Luther-Davies, Capital Territory (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/506,118

(22) PCT Filed: Mar. 5, 2003
(86) PCT No.: PCT/AU03/00268

(30) Foreign Application Priority Data
Mar. 7, 2002 (AU) PS 0969

(51) Int. Cl. G02B 6/26

(52) U.S. Cl. 385/16; 385/37

(57) ABSTRACT

A tuneable filter arrangement (10) includes a plurality of tuneable Bragg gratings (22, 24), each grating (22, 24) arranged, in use, to be independently tuneable to different wavelengths, a first switch (16) for selectively directing an incoming optical signal (26) to any one of the gratings (22, 24), a first optical element (18) arranged, in use, such that an optical signal transmitted through any one of the gratings (22, 24) is directable to a through-output of the filter arrangement (10), and an optical drop structure (20) arranged, in use, such that a filtered optical signal from any one of the gratings (22, 24) is dropped at a drop-output (28) of the filter arrangement (10). The first switch (16) and the first optical element (18) maybe Y junction thermo-optic switches, and the optical drop structure (20) may be an optical circulator. Another optical circulator may be provided at the through-output of the filter arrangement (10) for adding WDM channels to the through-output signal.

### FIELD OF THE INVENTION

The present invention relates broadly to a tuneable filter arrangement and to a method of tuneably filtering an optical signal.

### BACKGROUND OF THE INVENTION

Tuneable filters are important in photonic technology to e.g. select individual wavelength channels from wavelength division multiplexed (WDM) signals.

In particular for dense WDM signals, which are significant in e.g. optical networks, a problem associated with existing tuneable filters is that the active filter needs to be tuned or “slid” across all available channels during tuning at e.g. a tuneable optical add/drop multiplexer (OADM). This can result in “unclean” (“non-ideal”) behaviour of the tuneable filter, which can impact on the optical signal passing through the tuneable filter.

The present invention seeks to provide a novel tuneable filter arrangement which, in at least preferred embodiments, solves the problem of sliding tuneable filtered structures across all channels while the WDM signal passes through the tuneable filter.

### SUMMARY OF THE INVENTION

In accordance with a first aspect of the present invention there is provided a tuneable filter arrangement, the filter arrangement comprising a plurality of tuneable filter structures, each filter structure arranged, in use, to be independently tuneable to different wavelengths, an optical switch for selectively directing an incoming optical signal to one of the filter structures, a first optical element arranged, in use, such that an optical signal from any one of the filter structures is directable to a through-output of the filter arrangement, and an optical drop structure arranged, in use, such that a filtered optical signal from any one of the filter structures is dropped at a drop-output of the filter arrangement.

Accordingly, the incoming signal can be routed through one tuneable filter structure by appropriately configuring the optical switch. To change the wavelength of the dropped channel, an “out-of-circuit” tuneable filter is tuned to the required wavelength. Once that has been reached, the signal is routed to that tuneable filter by changing the state of the optical switch. The other (or another) tuneable filter, which now becomes the “out-of-circuit” filter, can then be tuned to the next operational wavelength. In this manner, the dropped wavelength can be adjusted between random wavelengths without the need for the active tuneable filter to “slide” across the optical signal.

In a preferred embodiment, the filter structures comprise Bragg grating structures.

The optical drop structure may comprise an optical circulator disposed on the input-side of the first optical switch.

In one embodiment, the first optical element comprises a second optical switch for selectively directing the optical signal from any one of the waveguide channels to the through-output.

The filter structures may comprise one or more of the group of thermally, electrically, acoustically, or mechanically tuneable filter structures.

The optical switches may comprise one or more of the group of thermally, electrically, acoustically, optically or mechanically operated switch structure.

Each filter structure may comprise a pair of simultaneously tuneable gratings, each grating being located in a different waveguide channel, and the optical drop structure may comprise a first directional coupler element associated with each pair of gratings and arranged, in use, to split the incoming optical signal between the waveguide channels, and to direct the filtered optical signals from both gratings of the pair to the drop-output of the filter arrangement, and wherein the filter arrangement further comprises a second directional coupler element associated with each pair of gratings and arranged, in use, to combine the optical signals transmitted through the gratings of the pair.

The filter arrangement may further comprise an optical add structure, and the filter arrangement may be arranged, in use, such that an optical add signal added via the optical add structure is selectively directed to any one of the filter structures and in a direction opposite to the incoming optical signal, whereby the optical add signal is reflected at the filter structure and added to the transmitted incoming optical signal.

The filter arrangement may be arranged for a WDM signal. The filter arrangement may be arranged for a dense WDM signal.

In accordance with a second aspect of the present invention there is provided a tuneable optical filter arrangement, the arrangement comprising a plurality of groups of at least two tuneable filter structures, each filter structure arranged, in use, to be independently tuneable to different wavelength, a plurality of optical by-pass channels, each by-pass channel being associated with one of the groups of filter structures, at least first, second, and third optical switches, wherein the first optical switch is arranged, in use, to selectively direct an incoming optical signal to any one of the filter structures of one group or to the by-pass channel associated with said one group, and the second optical switch is arranged, in use, to selectively direct an optical signal to any one of the filter structures of another group or to the by-pass channel associated with said other group, and the third optical switch is arranged, in use, to selectively direct optical signals from any one of the filter structures of said one group or from the by-pass channel associated with said one group to the input of the second optical switch, a first optical element arranged, in use, such that an optical signal from any one of said other group of filter structures or from the by-pass channel associated with said other with said other group is directable to a through-output of the filter arrangement, and an optical drop structure arranged, in use, such that a filtered optical signal from any one of the filter structures is dropped at a drop-output of the filter arrangement.

In a preferred embodiment, the filter structures comprise Bragg grating structures.

The optical drop structure may comprise an optical circulator disposed on the input-side of the first optical switch.

The filter structures may comprise one or more of the group of a thermally, electrically, acoustically, or mechanically tuneable filter structures.

The optical switches may comprise one or more of the group of thermally, electrically, acoustically, optically or mechanically operated switch structure.

The first optical element may comprise a fourth optical switch for selectively directing an optical signal from any one of said other group of waveguide channels or from the by-pass channel associated with said other group to the through-output.

Each tuneable filter structure may comprise a pair of simultaneously tuneable gratings, each grating being located in a different waveguide channel and the optical drop structure comprises a first directional coupler element associated with each pair of gratings and arranged, in use, to split the incoming optical signal between the waveguide channels, and to direct the filtered optical signals from both gratings of the pair to the drop-output of the filter arrangement, and wherein the filter arrangement further comprises a second directional coupler element associated with each pair of gratings and arranged, in use, to combine the optical signals transmitted through the gratings of the pair.

The filter arrangement may further comprise an optical add structure, and the filter arrangement may be arranged, in use, such that an optical add signal added via the optical add structure is selectively directed to any one of the filter structures and in a direction opposite to the incoming optical signal, whereby the optical add signal is reflected at the filter structure and added to the transmitted incoming optical signal.

The filter arrangement may be arranged for a WDM signal. The filter arrangement may be arranged for a dense WDM signal.

In accordance with a third aspect of the present invention there is provided a method of tuneably filtering an optical signal, the method comprising the steps of selectively routing the optical signal to one of a plurality of independently tuneable filter structures, filtering a selected wavelength at one of the filter structures, tuning another one of the filter structures to another wavelength, and routing the optical signal to the other waveguide channel for filtering at said other filter structure.

The method may further comprise the steps of dropping the filtered wavelength from the incoming optical signal.

The method may further comprise the step of selectively routing an optical add signal to one of the filter structures and in a direction opposite to the incoming optical signal, whereby the optical add signal is reflected at said one filter structure and added to the transmitted incoming optical signal.

Preferably, the tuneable filter structures comprise optical gratings.

The optical signal may comprise a WDM signal. The WDM signal may comprise a dense WDM signal.

### BRIEF DESCRIPTION OF THE DRAWINGS

Preferred embodiments of the present invention will now be described, by way of example only, with reference to the accompanying drawings.

FIG. 1 is a schematic drawing of a tuneable filter arrangement embodying the present invention.

FIG. 2 is a schematic drawing of another tuneable filter arrangement embodying the present invention.

FIG. 3 is a schematic drawing of another tuneable filter arrangement embodying the present invention.

FIG. 4 is a schematic drawing of another tuneable filter arrangement embodying the present invention.

### DETAILED DESCRIPTION OF THE EMBODIMENTS

The preferred embodiments described provide tuneable filter arrangements in which a dropped wavelength at the tuneable filter arrangement can be adjusted between random pairs of wavelengths without the need for an active filter structure to “slide” across the optical signal, e.g. across adjacent WDM channels.

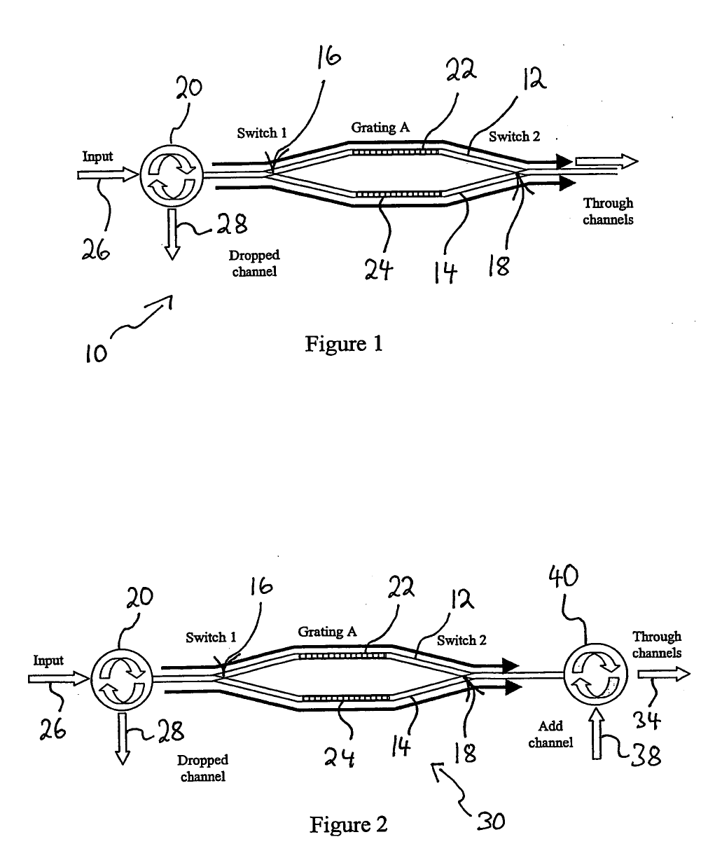

In FIG. 1, a tuneable filter arrangement 10 comprises two waveguide channels 12, 14 disposed in parallel between two y-junction thermo-optic switches 16, 18.

An optical circulator 20 is disposed at the input side of the optical switch 16.

Bragg gratings 22, 24 are disposed in the waveguide channels 12, 14 respectively. The gratings 22, 24 are each independently tuneable. In the example embodiment, the waveguide channels 12, 14 are made from inorganic polymer glass (IPG) and the gratings 22, 24 are tuneable utilising the thermo-optic sensitivity of IPGs, i.e. suitable heater elements (not shown) are provided in the regions of the gratings 22, 24. The example embodiment is configured as an IPG planar optical device.

In operation, an optical input signal 26 passing through the circulator 20 is routed at optical switch 16 through to one of the gratings, e.g. grating 22. The grating 22 is pre-tuned to a selected wavelength, and that wavelength is dropped at circulator 20 as indicated by arrow 28.

To change the wavelength of the dropped channel, the other grating 24, which effectively is “out-of-circuit” is tuned to the required central wavelength while being out-of-circuit. Once that wavelength has been reached, the optical switches 16 and 18 change state to route the input signal 26 to the grating 24. Grating 22 is now the “out-of-circuit” grating, and can be tuned to the next operational wavelength. The switching can then be repeated to adjust the dropped wavelength as required.

It will be appreciated by a person skilled in the art that in this manner the dropped wavelength can adjusted between random pairs of wavelength without the need for an active filter to “slide” across the optical signal, e.g. across adjacent WDM channels, while being “in-circuit”.

FIG. 2 shows a modified tuneable filter arrangement 30, which, in addition to the components of the tuneable filter arrangement 10 (see FIG. 1), comprises another optical circulator 40. It will be appreciated by the person skilled in the art, that the tuneable filter arrangement 30 is thus arranged for adding WDM channels at the second optical circulator 40 to the WDM signal leaving the filter arrangement 30 at the through-output 34.

Operationally, an added WDM channel signal at port 36 of circulator 38 is routed at optical switch 18 to one of the gratings 22 or 24, which is tuned to the required central wavelength for reflecting the added WDM channel signal. The added WDM channel signal is reflected at the grating 22 or 24 and leaves the filter arrangement 30 at the through-output 34 via circulator 40. As the optical switches 16 and 18 are switched to step through different WDM channel wavelengths, different WDM channels can be added corresponding to changes in the dropped WDM channel as described above.

It will be appreciated by the person skilled in the art that where a required tuning range, e.g. the full tuning range across all channels of a WDM signal, can not be achieved by using one pair of gratings, one or more further waveguide channels incorporating tuneable filters may be added, in parallel, between suitable switch/junction units without departing from the scope of the present invention.

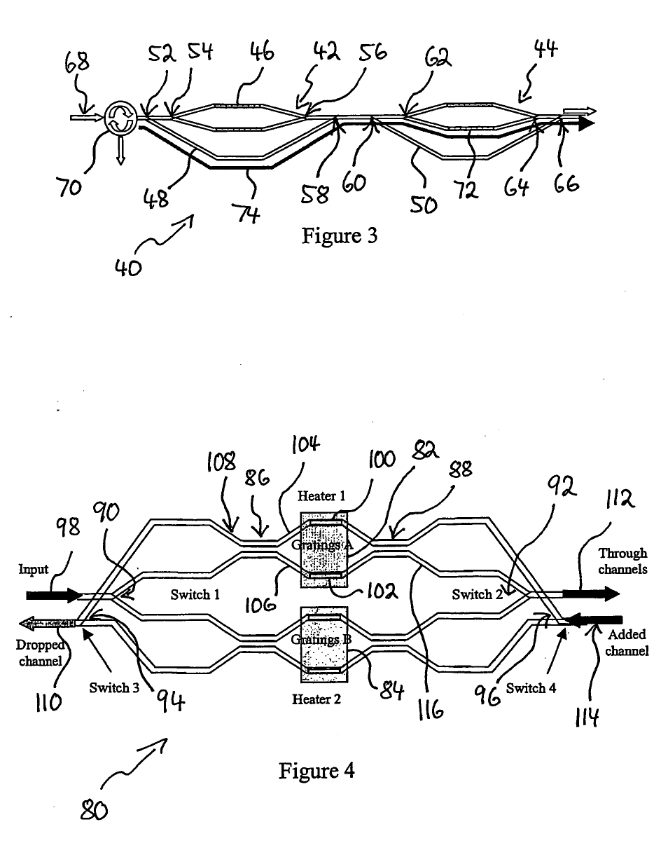

In an alternative embodiment, shown in FIG. 3, another tuneable filter arrangement 40 embodying the present invention comprises two pairs 42, 44 of waveguide channels, in the example embodiment Inorganic Polymer Glass (IPG) planar waveguide channels. Each waveguide channel comprises an optical grating e.g. 46. Again, the gratings e.g. 46 are tuneable utilising suitable heater elements (not shown) for thermo-optic tuning of the centre wavelength of the respective grating e.g. 46.

The tuneable filter arrangement 40 further comprises two by-pass channels 48, 50, associated with the pairs of waveguide channels 42, 44 respectively.

The filter arrangement 40 further comprises optical y-junction digital thermo-optic switches 52, 54, 56, 58, 60, 62, 64, 66. Operationally, an optical input signal 68 passing through the circulator 70 of the filter arrangement 40 is routed to the appropriate grating by suitable optical switching. In the example configuration shown in FIG. 3, the input signal 68 by-passes the first pair of waveguide channels 42 and is then routed to the grating 72 in one of the waveguide channels in the second pair 44, as indicated by the filled trace arrow 74 in FIG. 3.

Accordingly, the filter arrangement 40 can provide an expanded tuning range compared to what would be achievable with only one pair of tuneable filters of a given tuning range. One or more further waveguide channels incorporating tuneable filters may be added in series with each of the pairs between suitable switch/junction units, and/or one or more pairs or groups of waveguide channels incorporating tuneable filters may be added utilising suitable switch/junction units without departing from the scope of the present invention.

Turning now to FIG. 4, an example embodiment suitable for an integrated planar implementation will be described. In this embodiment, an optical add drop multiplexer (OADM) 80 comprises two pairs of gratings 82, 84. Each pair of gratings 82, 84 is disposed between a pair of 3 dB directional couplers e.g. 86 and 88 for the pair of gratings 82. The OADM 80 further comprises four optical switches 90, 92, 94, and 96.

Operationally, a WDM input signal 98 is routed utilising optical switch 90 through to one of the pairs of gratings, e.g. pair 82. Both gratings 100, 102 of the pair 82 are pre-tuned to the same selected wavelength. The routed signal is split 50%-50%. The output of the coupler 86 is recombined at a second, in the example embodiment identical coupler 88. In the example embodiment, the couplers e.g. 86, 88 are based on simple waveguide coupler devices, however, it will be appreciated by the persons skilled in the art that the couplers can take another form in other embodiments of the present invention, such as e.g. being based on Multi-Mode Interference (MMI) structures.

Because of the phase difference introduced by the coupler 86 in the light signal travelling in the arms 104, 106 containing the gratings 100, 102 respectively, the back-reflected light at the selected wavelength emerges from a drop part 108 of the coupler 86 and is directed to a drop-output of the OADM 80 via optical switch 94, as indicated at numeral 110.

To change the wavelength of the drop channel, the gratings of the other pair of gratings 84, which are out-off circuit, are tuned to the required central wavelength while being out-off-circuit. Once that wavelength has been reached, the optical switches 90, 92, 94, 96 change state to route the input signal 98 to the pair of gratings 84 and through to through-output at numeral 112, and the WDM channel reflected at the pair of gratings 84 to the drop-output at numeral 110. The pair of gratings 82 is now the out-off circuit, and can be tuned to the next operational wavelength. The switching can then be repeated to adjust the wavelength as required.

A WDM channel signal added at the OADM 80 at numeral 114 is routed at optical switch 96 through to one of the pairs of gratings, e.g. the pair of gratings 82. The added channel signal is split 50%-50% at optical coupler 88 prior to being reflected at optical gratings 100 and 102, which are pre-tuned to the wavelength of the added channel signal. Because of the phase difference introduced by optical coupler 88, the back-reflected light emerges from a drop port 116 of the coupler 88 and is thus “added” to the optical signal leaving the OADM 80 at numeral 112 via optical switch 92. As the optical switches 90, 92, 94, and 96 are switched to step through different WDM channel wavelengths, different WDM channels can be added, corresponding to changes in the dropped WDM channel as described above.

It will be appreciated by the persons skilled in the art that the OADM 80 is suitable for a planar implementation, i.e. it does not require bulk optics circulators of the previous embodiments described with reference to FIGS. 1 to 3, which would have to be added external to an OADM chip.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

For example, it will be appreciated that the present invention is not limited to the use of Bragg gratings as the tuneable filter devices in the waveguide channels. Rather, the present invention can be implemented using any tuneable filter devices In the claims that follow and in the summary of the invention, except where the context requires otherwise due to express language or necessary implication the word “comprising” is used in the sense of “including”, i.e. the features specified may be associated with further features in various embodiments of the invention.

1. A tuneable filter arrangement, the filter arrangement comprising:
a plurality of tuneable filter structures, each filter structure arranged, in use, to be independently tuneable to different wavelengths,
a first optical switch for selectively directing an incoming optical signal to any one of the filter structures,
a first optical element arranged, in use, such that an optical signal transmitted through any one of the filter structures is directable to a through-output of the filter arrangement, and
an optical drop structure arranged, in use, such that a filtered optical signal from any one of the filter structures is dropped at a drop-output of the filter arrangement.

2. A filter arrangement as claimed in claim 1, wherein the filter structures comprise Bragg grating structures.

3. A filter arrangement as claimed in claim 1, wherein the optical drop structure comprises an optical circulator disposed on the input-side of the first optical switch.

4. A filter arrangement as claimed in claim 1, wherein the first optical element comprises a second optical switch for selectively directing the transmitted optical signal from any one of the filter structures to the through-output.

5. A filter arrangement as claimed in claim 1, wherein each filter structure comprises a pair of simultaneously tuneable gratings, each grating being located in a different waveguide channel, and the optical drop structure comprises a first directional coupler element associated with each pair of gratings and arranged, in use, to split the incoming optical signal between the waveguide channels, and to direct the filtered optical signals from both gratings of the pair to the drop-output of the filter arrangement, and wherein the filter arrangement further comprises a second directional coupler element associated with each pair of gratings and arranged, in use, to combine the optical signals transmitted through the gratings of the pair.

6. A filter arrangement as claimed in claim 1, wherein the filter structures are selected from a group of thermally, electrically, acoustically, or mechanically tuneable filter structures.

7. A filter arrangement as claimed in claim 1, wherein the optical switches are selected from a group of thermally, electrically, acoustically, optically or mechanically operated switch structures.

8. A filter arrangement as claimed in claim 1, wherein the filter arrangement further comprises an optical add structure, and the filter arrangement is arranged, in use, such that an optical add signal added via the optical add element structure is selectively directed to any one of the filter structures and in a direction opposite to the incoming optical signal, whereby the optical add signal is reflected at the filter structure and added to the transmitted incoming optical signal.

9. A filter arrangement as claimed in claim 1, wherein the filter arrangement is arranged for a WDM signal.

10. A filter arrangement as claimed in claim 9, wherein the filter arrangement is arranged for a dense WDM signal.

11. A tuneable optical filter arrangement, the arrangement comprising:
a plurality of groups of at least two tuneable filter structures, each filter structure arranged, in use, to be independently tuneable to different wavelengths,
a plurality of optical by-pass channels, each by-pass channel being associated with one of the groups of filter structures,
at least first, second, and third optical switches, wherein
the first optical switch is arranged, in use, to selectively direct an incoming optical signal to any one of the filter structures of one group or to the by-pass channel associated with said one group,
the second optical switch is arranged, in use, to selectively direct an optical signal to any one of the filter structures of another group or to the by-pass channel associated with said other group, and
the third optical switch is arranged, in use, to selectively direct optical signals from said one group of filter structures or from the by-pass channel associated with said one group to the input of the second optical switch,
a first optical element arranged, in use, such that an optical signal from any one of said other group of filter structures or from the by-pass channel associated with said other group is directable to a through-output of the filter arrangement, and
an optical drop structure arranged, in use, such that a filtered optical signal from any one of the filter structures is dropped at a drop-output of the filter arrangement.

12. A filter arrangement as claimed in claim 11, wherein the filter structures comprise Bragg grating structures.

13. A filter arrangement as claimed in claim 11, wherein the optical drop structure comprises an optical circulator disposed on the input-side of the first optical switch.

14. A filter arrangement as claimed in claim 11, wherein the filter structures are selected from a group of thermally, electrically, acoustically, or mechanically tuneable filter structures.

15. A filter arrangement as claimed in claim 11, wherein the optical switches are selected from a group of thermally, electrically, acoustically, optically or mechanically operated switch structures.

16. A filter arrangement as claimed in claim 11, wherein the first optical element comprises a fourth optical switch for selectively directing an optical signal from said other group of waveguide channels or from the by-pass channel associated with said other group to the through-output.

17. A filter arrangement as claimed in claim 11, wherein each tuneable filter structure comprises a pair of simultaneously tuneable gratings, each grating being located in a different waveguide channel, and the optical drop structure comprises a first directional coupler element associated with each pair of gratings and arranged, in use, to split the incoming optical signal between the waveguide channels, and to direct the filtered optical signals from both gratings of the pair to the drop-output of the filter arrangement, and wherein the filter arrangement further comprises a second directional coupler element associated with each pair of gratings and arranged, in use, to combine the optical signals transmitted through the gratings of the pair.

18. A filter arrangement as claimed in claim 11, wherein the filter arrangement further comprises an optical add structure, and the filter arrangement is arranged, in use, such that an optical add signal added via the optical add structure is selectively directed to any one of the filter structures and in a direction opposite to the incoming optical signal, whereby the optical add signal is reflected at the filter structure and added to the transmitted incoming optical signal.

19. A filter arrangement as claimed in claim 11, wherein the filter arrangement is arranged for a WDM signal.

20. A filter arrangement as claimed in claim 19, wherein the filter arrangement is arranged for a dense WDM signal.

21. A method of tuneably filtering an incoming optical signal, the method comprising:
selectively routing the incoming optical signal to one of a plurality of independently tuneable filter structures,
filtering a selected wavelength at said one of the filter structures,
tuning another one of the filter structures to another wavelength, and
routing the optical signal to the other waveguide channel for filtering at said other filter structure.

22. A method as claimed in claim 21, wherein the method further comprises the step of dropping the filtered wavelengths from the incoming optical signal.

23. A method as claimed in claim 21, wherein the method further comprises the step of selectively routing an optical add signal to one of the filter structures and in a direction opposite to the incoming optical signal, whereby the optical add signal is reflected at said one filter structure and added to the transmitted incoming optical signal.

24. A method as claimed in claim 21, wherein the tuneable filter structures comprise optical gratings.

25. A method as claimed in claim 21, wherein the optical signal comprises a WDM signal.

26. A method as claimed in claim 25, wherein the WDM signal comprises a dense WDM signal.
